(19) United States
(12) Patent Application Publication
(10) Pub. No.: US 2016/0350257 A1
(43) Pub. Date: Dec. 1, 2016

(54) BACKPLANE AND HARD DISK DRIVE COMPATIBLE CIRCUIT THEREOF

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: KANG WU, Shenzhen (CN); GUO-YI CHEN, Shenzhen (CN)

(21) Appl. No.: 14/750,564

(22) Filed: Jun. 25, 2015

(30) Foreign Application Priority Data
May 25, 2015 (CN) 201510269162.X

(51) Int. Cl. G06F 13/42; G06F 13/40; G06F 3/06

(52) U.S. Cl. CPC G06F 13/4282; G06F 3/068; G06F 3/0659; G06F 3/061; G06F 13/4022

(57) ABSTRACT

A backplane includes a hard disk drive (HDD) compatible circuit for making a motherboard compatible with a first HDD and a second HDD. The HDD compatible circuit includes a first connector for connecting to the first HDD or the second HDD, a switch module connected to the first connector, a second connector connected to the switch module and the motherboard, and a third connector connected to the switch module and the motherboard. When the switch module detects the first HDD is electrically coupled to the first connector, the switch module connects the first connector to the second connector, and the first HDD communicates with the motherboard. When the switch module detects the second HDD is electrically coupled to the first connector, the switch module connects the first connector to the third connector, and the second HDD communicates with the motherboard.

### FIELD

The subject matter herein generally relates to backplanes and particularly to a backplane with a hard disk drive compatible circuit.

### BACKGROUND

There are many types of hard disk drives (HDDs), such as a peripheral component interconnect express (PCIE) HDD and a serial attached small computer system interface (SAS) HDD. However, a traditional motherboard has only one type of HDD interface to connect one type of HDDs.

### BRIEF DESCRIPTION OF THE DRAWINGS

Implementations of the present technology will now be described, by way of example only, with reference to the attached figures.

FIG. 1 is a block diagram of an embodiment of a backplane.

FIG. 2 is a block diagram of an embodiment of the backplane.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series and the like.

The present disclosure is described in relation to a backplane and a hard disk drive (HDD) compatible circuit of the backplane.

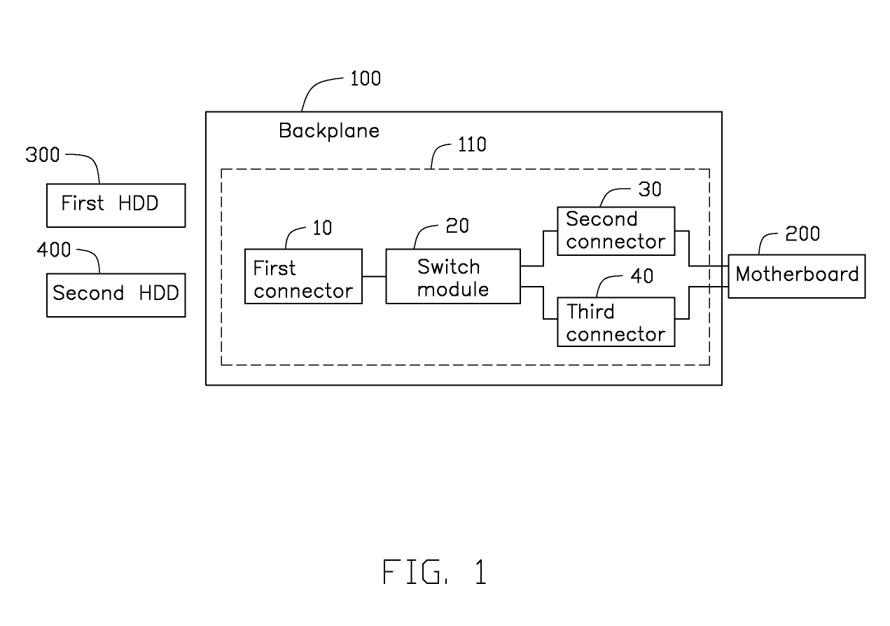

FIG. 1 illustrates an embodiment of a backplane 100. The backplane 100 can comprise a HDD compatible circuit 110 configured for making a motherboard 200 compatible with a first HDD 300 and a second HDD 400. The HDD compatible circuit 110 can comprise a first connector 10, a switch module 20, a second connector 30, and a third connector 40. The first connector 10 is electrically coupled to the switch module 20. The switch module 20 is electrically coupled to the motherboard 200 through the second connector 30, and the switch module 20 is electrically coupled to the motherboard 200 through the third connector 40. The first connector 10 is configured to be electrically coupled to the first HDD 300 or the second HDD 400. The switch module 20 is configured to detect that the first connector 10 is electrically coupled to the first HDD 300 or the second HDD 400, and controls the first connector 10 to be electrically coupled to the second connector 30 or the third connector 40, according to the detected result.

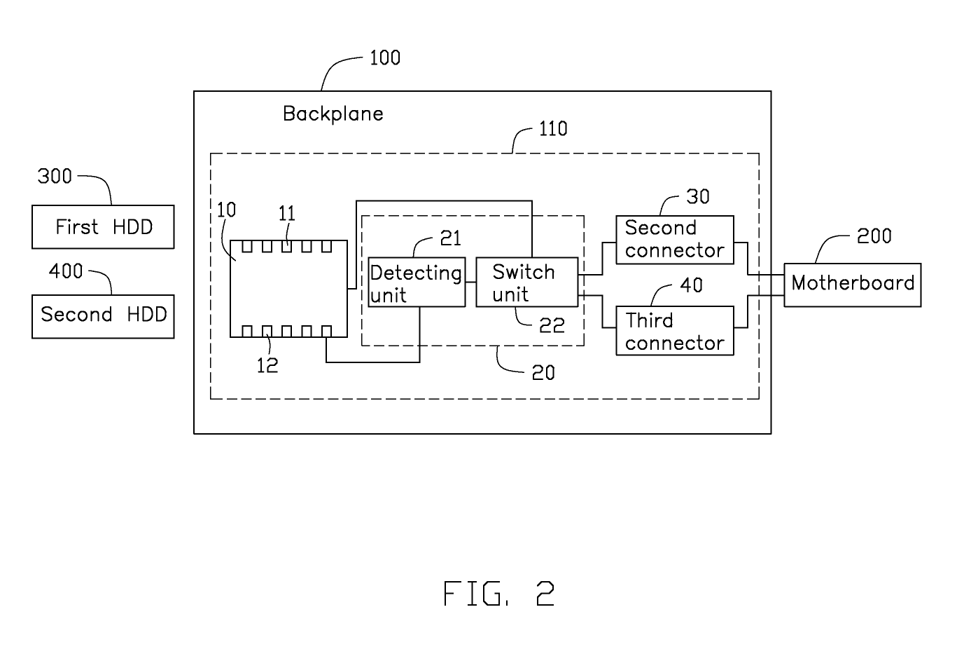

FIG. 2 illustrates an embodiment of the HDD compatible circuit 110. The first connector 10 can comprises a plurality of first pins 11 and a plurality of second pins 12. The first pins 11 are configured to be electrically coupled to the first HDD 300, and the first pins 11 and the second pins 12 can be configured together to be electrically coupled to the second HDD 400. The switch module 20 can comprises a detecting unit 21 and a switch unit 22. The detecting unit 21 is electrically coupled to one of the second pins 12. In at least one embodiment, the second pins 12 are defaulted at high level when they are suspended. The switch unit 22 is electrically coupled to the first connector 10, the second connector 30, and the third connector 40. The second connector 30 is configured for transmitting a first signal and the third connector 40 is configured for transmitting a second signal.

When the first HDD 300 is electrically coupled to the first connector 10, the first pins 11 are electrically coupled to the first HDD 300 and the second pins 12 are suspended. The detecting unit 21 sends a first control signal to the switch unit 22 after receiving the high level signal from the one of the second pins 12. The switch unit 22 controls the first connector 10 to be electrically coupled the second connector 30, and controls the first connector 10 to be disconnected from the third connector 40, after receiving the first control signal. The first HDD 300 communicates with the motherboard 200 through the first connector 10, the switch unit 22, and the second connector 30.

When the second HDD 400 is electrically coupled to the first connector 10, the first pins 11 and the second pins 12 are electrically coupled to the first HDD 300. The detecting unit 21 sends a second control signal to the switch unit 22 after receiving a low level signal from the one of the second pins 12. The switch unit 22 controls the first connector 10 to be electrically coupled the third connector 40, and controls the first connector 10 to be disconnected from the second connector 30, after receiving the second control signal. The second HDD 400 can communicate with the motherboard 200 through the first connector 10, the switch unit 22, and the third connector 40.

In at least one embodiment, the first HDD 300 can be a peripheral component interconnect express (PCIE) HDD and the second HDD 400 can be a serial attached small computer system interface (SAS) HDD. The first signal can be PCIE signal and the second signal can be SAS signal. In other embodiments, the first HDD 300 can be a serial advanced technology attachment (SATA) HDD and the second HDD 400 can be a small computer system interface (SCSI) HDD. The first signal can be SATA signal and the second signal can be SCSI signal.

As detailed above, the HDD compatible circuit 110 uses the switch module 30 detecting type of the HDD electrically coupled to the first connector 10, then controls the first connector 10 to be electrically coupled to the second connector 30 or the third connector 40 according to the detected results. Then, different types of HDDs can be electrically coupled to the motherboard 200 for transmitting data.

The embodiments shown and described above are only examples. Many details are well known by those in the art therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A hard disk drive (HDD) compatible circuit comprising:
a first connector configured to be electrically coupled to at least one of a first HDD and a second HDD;
a switch module electrically coupled to the first connector;
a second connector electrically coupled to the switch module and the motherboard; and
a third connector electrically coupled to the switching module and the motherboard;
wherein the switch module is configured to control the first connector to be electrically coupled to the second connector, and to enable the first HDD to communicate with the motherboard through the first connector, the switch module, and the second connector, in event that the switch module detects that the first HDD is electrically coupled to the first connector; and
wherein the switch module is further configured to control the first connector to be electrically coupled to the third connector, and to enable the second HDD to communicate with the motherboard through the first connector, the switch module, and the second connector, in event that the switch module detects that the second HDD is electrically coupled to the first connector.

2. The HDD compatible circuit of claim 1, wherein the switch module comprises a detecting unit and a switch unit, the detecting unit is electrically coupled to the first connector; the switching unit is electrically coupled to the first connector, the second connector, the third connector, and the detecting unit;
wherein the detecting unit sends a first control signal to the switch unit when the detecting unit detects that the first HDD is electrically coupled to the first connector, the switching unit controls the first connector to be electrically coupled the second connector after receiving the first control signal; and
wherein the detecting unit sends a second control signal to the switch unit when the detecting unit detecting that the second HDD is electrically coupled to the first connector, the switching unit controls the first connector to be electrically coupled the third connector after receiving the second control signal.

3. The HDD compatible circuit of claim 2, wherein the first connector comprises a plurality of first pins and a plurality of second pins, the detecting unit is electrically coupled to one of the second pins;
wherein the first pins are electrically coupled to the first HDD and the second pins are suspended, the detecting unit sends the first control signal to the switch unit after receiving a high level signal from the one of the second pins, in event that the first HDD is electrically coupled to the first connector; and
wherein the first pins and the second pins are electrically coupled to the second HDD, the detecting unit sends the second control signal to the switch unit after receiving a low level signal from the one of the second pins, in event that the second HDD is electrically coupled to the first connector.

4. A backplane comprising a HDD compatible circuit, the HDD compatible circuit comprising:
a first connector configured to be electrically coupled to at least one of a first HDD and a second HDD;
a switch module electrically coupled to the first connector;
a second connector electrically coupled to the switch module and the motherboard; and
a third connector electrically coupled to the switching module and the motherboard;
wherein the switch module is configured to control the first connector to be electrically coupled to the second connector, and to enable the first HDD to communicate with the motherboard through the first connector, the switch module, and the second connector, in event that the switch module detects that the first HDD is electrically coupled to the first connector; and
wherein the switch module is further configured to control the first connector to be electrically coupled to the third connector, and to enable the second HDD to communicate with the motherboard through the first connector, the switch module, and the second connector, in event that the switch module detects that the second HDD is electrically coupled to the first connector.

5. The backplane of claim 4, wherein the switch module comprises a detecting unit and a switch unit, the detecting unit is electrically coupled to the first connector; the switching unit is electrically coupled to the first connector, the second connector, the third connector, and the detecting unit;
wherein the detecting unit sends a first control signal to the switch unit when the detecting unit detects that the first HDD is electrically coupled to the first connector, the switching unit controls the first connector to be electrically coupled the second connector after receiving the first control signal; and
wherein the detecting unit sends a second control signal to the switch unit when the detecting unit detecting that the second HDD is electrically coupled to the first connector, the switching unit controls the first connector to be electrically coupled the third connector after receiving the second control signal.

6. The backplane of claim 5, wherein the first connector comprises a plurality of first pins and a plurality of second pins, the detecting unit is electrically coupled to one of the second pins;
wherein the first pins are electrically coupled to the first HDD and the second pins are suspended, the detecting unit sends the first control signal to the switch unit after receiving a high level signal from the one of the second pins, in event that the first HDD is electrically coupled to the first connector; and
wherein the first pins and the second pins are electrically coupled to the second HDD, the detecting unit sends the second control signal to the switch unit after receiving a low level signal from the one of the second pins, in event that the second HDD is electrically coupled to the first connector.
